(19) United States
(12) Patent Application Publication
(10) Pub. No.: US 2014/0114840 A1
(43) Pub. Date: Apr. 24, 2014

(54) AUTOMATED FRAUD DETECTION

(71) Applicant: CELLCO PARTNERSHIP D/B/A VERIZON WIRELESS, Arlington, VA (US)

(72) Inventors: Robert E. Arnold, Simpsonville, SC (US); Jonathan E. Geckle, Little Rock, AR (US)

(73) Assignee: Cellco Partnership d/b/a Verizon Wireless, Arlington, VA (US)

(21) Appl. No.: 13/655,759

(22) Filed: Oct. 19, 2012

(51) Int. Cl. G06Q 20/22

(52) U.S. Cl. 705/39

(57) ABSTRACT

A system includes a transaction server configured to receive and process retail transactions. A fraud detection server is in communication with the transaction server and is configured to generate a plurality of fraud models from a first subset of the retail transactions. Each fraud model represents a potentially fraudulent transaction. The fraud detection server further predicts an effectiveness of each of the plurality of fraud models to identify potentially fraudulent transactions, selects the fraud model based at least in part on the predicted effectiveness based on the first subset of the retail transactions, and transmits the selected fraud model to the transaction server. The transaction server is configured to apply the selected fraud model to at least a second subset of the retail transactions to identify potentially fraudulent transactions.

### BACKGROUND

Retailers routinely encounter fraudulent transactions. Fraudulent transactions occur, for example, when a thief tries to use a misappropriated credit card to make a purchase or when a thief impersonates a new or existing customer. Such fraudulent transactions hurt retailers and consumers. Identifying fraudulent transactions as quickly as possible is beneficial for retailers and consumers since it may increase the likelihood of law enforcement officials locating and apprehending the perpetrator.

### BRIEF DESCRIPTION OF THE DRAWINGS

FIG. 1 illustrates an exemplary system configured to automatically detect fraudulent transactions.

FIG. 2 illustrates a chart that illustrates example attributes and values associated with those attributes that may be used in fraud models to detect fraudulent transactions.

FIG. 3 illustrates an example gains plot that may be used to compare a particular fraud model to a control scenario and to other fraud models.

FIG. 4 is a flowchart of an exemplary process that may be used to detect fraudulent transactions.

FIG. 5 is a flowchart of an exemplary process that may be used to generate multiple fraud models based on attributes most commonly associated with fraudulent transactions.

### DETAILED DESCRIPTION

An exemplary system may include a transaction server that can receive and process retail transactions and a fraud detection server that can communicate with the transaction server. The fraud detection server may generate a plurality of possible fraud models from a first subset of the retail transactions. Each fraud model represents a potentially fraudulent transaction. The fraud detection server may predict an effectiveness of each of the plurality of fraud models to identify potentially fraudulent transactions based on the first subset of the retail transactions and select one of the fraud models based, at least in part, on the predicted effectiveness. The fraud detection server may transmit the selected fraud model to the transaction server, which may then apply the selected fraud model to at least a second subset of retail transactions to identify potentially fraudulent transactions.

Accordingly, the exemplary system can build fraud models to detect potentially fraudulent transactions. Indeed, multiple fraud models may be generated, and the system may determine which is likely to be the most effective at identifying potential instances of fraud given certain circumstances, described in greater detail below. When a potential instance of fraud is identified, a fraud investigator may review the affected transaction to determine whether it is indeed fraudulent. If so, the investigator may cancel the transaction and, in some instances, alert law enforcement officials. Alternatively, the law enforcement officials may be notified of the fraudulent transaction directly from the transaction server without human intervention.

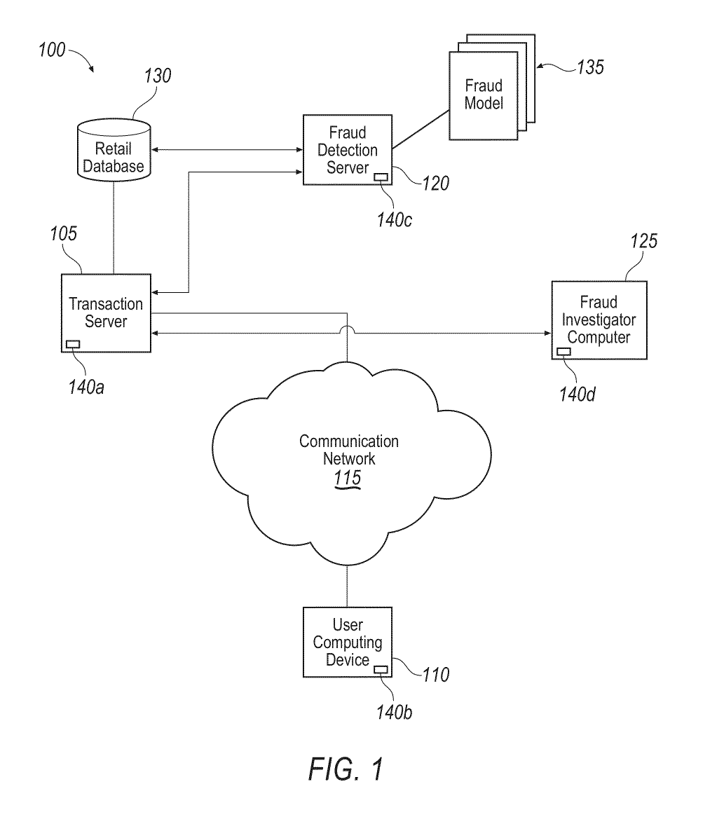

FIG. 1 illustrates an exemplary system 100 that can automatically detect potentially fraudulent transactions. The system may take many different forms and include multiple or possibly alternate components and facilities. While an exemplary system is shown in FIG. 1, the exemplary components illustrated in the figures are not intended to be limiting. Indeed, additional or alternative components or implementations may be used.

As illustrated in FIG. 1, the system 100 includes a transaction server 105 and a user computing device 110 in communication over a communication network 115, such as a telecommunications network or a computer network. The system 100 as illustrated further includes a fraud detection server 120 in communication with the transaction server 105 and a fraud investigator computer 125.

The transaction server 105 may include any device or devices configured to receive and process retail transactions. Retail transactions may include purchases made over a network, such as the Internet or a cellular network, or in a traditional brick-and-mortar store. Each retail transaction may be associated with one or more attributes. Generally, an attribute may describe a characteristic of a consumer or retailer involved in the retail transaction. The attribute may further or alternatively define a characteristic of the transaction itself Examples of attributes may include the purchase price, the shipping address (e.g., street name, city, state, ZIP code, country, etc.), the billing address (e.g., street name, city, state, ZIP code, country, etc.), whether the shipping and billing addresses are the same, a description of the product purchased, the number of products purchased, the total order price, method of payment, or the like. Any of these and possibly other attributes may be associated with each retail transaction and stored in one or more retail databases 130, which may be part of or separate from the transaction server 105. The retail database 130 may further include previous retail transactions and their associated attributes. This way, the retail database 130 stores current and historical information about retail transactions. The retail database 130 may store historical information going back any amount of time. For instance, the historical information may include retail transactions from the last week, six months, or even ten (10) years depending on various factors such as database size, storage space, etc. As will be discussed in greater detail below, the transaction server 105 may include at least one processor 140A configured to facilitate the application of various models to incoming retail transactions or retail transactions stored in the retail database 130. Each model may be thought of as a filter that can be used to query the retail transactions for transactions that have particular attributes.

The user computing device 110 may include a processor 140B configured to allow the user computing device 110 to carry out retail transactions over the communication network 115. In one exemplary approach, the user computing device 110 may be configured to allow a user to carry out retail transactions over the communication network 115. Using the user computing device 110, the user may carry out a retail transaction (e.g., placing an order for a product to be shipped to the user) with an online retailer. The user may use the user computing device 110 to access a retail webpage, select one or more items for purchase, enter billing and shipping information, and confirm the purchase. The information associated with the retail transaction may be communicated to the transaction server 105 for processing and fulfillment. The user computing device 110 may include any one or more of a desktop computer, a laptop computer, a mobile phone, a tablet computer, or the like.

The fraud detection server 120 may be configured to detect which of the retail transactions are potentially fraudulent. The fraud detection server 120 may include one or more processors 140C and may be in communication with the transaction server 105 and the retail database 130. Using the historical information stored in the retail database 130, the fraud detection server 120 may be configured to generate a plurality of fraud models 135, each representing a potentially fraudulent transaction. As discussed in greater detail below, each fraud model 135 may be thought of as a filter that, when applied to retail transactions, identifies those which have the most potential to be fraudulent. In addition to attributes, the historical information stored in the retail database 130 may also help to identify current retail transactions that are potentially fraudulent.

The fraud detection server 120 may be configured to associate attributes stored in the retail database 130 with a fraud risk based, e.g., on which attributes have been part of fraudulent transactions in the past. In other words, the fraud detection server 120 may be configured to determine which attributes are commonly associated with fraudulent transactions. For instance, understanding that fraudulent transactions can originate anywhere, the fraud detection server 120 may be configured to determine that a significant number of fraudulent transactions originate in one geographical area (i.e., “State A”) and that very few fraudulent transactions originate in another geographical area (i.e., “State B”). Therefore, the attribute associated with “State A” may be assigned a higher fraud risk than the attribute associated with “State B.” Another example may be based on the purchase price. The fraud detection server 120 may be configured to determine which ranges of purchase price have the highest fraud potential and which ranges of purchase price have the lowest fraud potential. The attributes representing those purchase prices may be assigned fraud risks accordingly by the fraud detection server 120.

The fraud detection server 120 has been discussed in the context of identifying potentially fraudulent transactions at the retail level. In some instances, the fraud detection server 120 may be implemented by financial institutions, e.g., banks or credit card companies, to detect fraud at the consumer level. For example, the fraud detection server 120 may associate a higher fraud risk to a credit card number following an unusually large number of purchases made within a relatively short period of time and originating from a relatively unusual location. For instance, a higher fraud risk may be assigned to a credit card number if a large number of transactions originate from outside the United States but the rightful card holder is known to live and work in the United States. Also, the type of retailer may be indicative of fraud risk so the fraud detection server 120 may, in one possible approach, be configured to associate certain types of retailers with a higher fraud risk and others with a lower fraud risk. Some retailers that may be associated with a higher fraud risk may include online gambling websites, adult websites, or any retailer selling illegal goods or services. Other types of retailers with a high fraud risk may include legitimate corporations that sell popular consumer products or products that would have a high “street value” if stolen. Retailers that may be associated with a lower risk of fraud may include, e.g., branches of the Federal or local government, local corporations, retailers the rightful card holder has previously interacted with, corporations that sell products or services with a low “street value” if stolen, and the like. For instance, the fraud detection server 120 may be configured to determine that a retailer of popular electronic consumer devices is more likely to be the target of fraud than a local restaurant.

With the fraud risk associated with each of the attributes, the fraud detection server 120 may be configured to generate the plurality of fraud models 135 based on the attributes most commonly associated with fraudulent transactions. That is, the fraud detection server 120 may define one fraud model 135 using a single attribute, such as the single attribute with the highest fraud risk. Iteratively, the fraud detection server 120 may be configured to define other fraud models 135 with different numbers of attributes or possibly with different combinations of attributes. For example, the fraud detection server 120 may be configured to generate a first fraud model 135 that includes the attribute with the highest fraud risk. A second fraud model 135 that includes the two attributes with the highest and second-highest fraud risk may then be generated, and in a subsequent iteration, a third fraud model 135 combining the attributes with the three highest fraud risks may be generated by the fraud detection server 120, and so on. Alternatively, the fraud detection server 120 may be configured to generate multiple fraud models 135 with different combinations of attributes based on each attribute's fraud risk. For instance, a first fraud model 135 may be defined by the two attributes with the highest fraud risk and a second fraud model 135 may be defined by the attribute with the highest fraud risk and the attribute with the second-highest fraud risk.

To iteratively generate the fraud models 135, the fraud detection server 120 may be configured to bin attributes according to fraud risk. That is, the attributes most commonly associated with fraudulent transactions may be binned together while attributes least commonly associated with fraudulent transactions may be binned together. This binning process may be repeated until all attributes have been binned into groups representing “high risk,” “moderate risk,” or “low risk,” for example, according to each attribute's fraud risk. After the binning process is complete, the fraud detection server 120 may, using a high level variable reduction process, select the attribute with the highest fraud risk from the “high risk” bin and associate that attribute with the first fraud model 135. During a subsequent iteration, the fraud detection server 120 may select the two attributes with the highest fraud risks from the “high risk” bin and associate those attributes with the second fraud model 135. The third fraud model 135 may include the three attributes with the highest fraud risks from the “high risk” bin, the fourth fraud model 135 may include the four attributes with the highest fraud risks from the “high risk” bin, and so on. In one possible approach, the number of fraud models 135 generated may be equal to the number of attributes in the “high risk” bin, the number of possible combinations of attributes in the “high risk” bin, or any combination thereof. For example, if there are twenty (20) attributes in the “high risk” bin, the fraud detection server 120 may be configured to generate twenty fraud models 135, each with a different number or combination of attributes. Because the fraud models 135 are generated based on the attributes with the highest fraud risk, the fraud models 135 each represent a potentially fraudulent transaction.

In some implementations, the fraud models 135 may include “low risk” attributes, which may include attributes that are associated with a low risk of fraud. When included in the fraud model 135, the combination of “high risk” attributes and “low risk” attributes may identify potentially fraudulent transactions as those with the “high risk” attributes and not the “low risk” attributes. By way of example, geographical area “State A” may be generally associated with a “high risk” attribute but a particular sub-geographical area (i.e., “City A”) within “State A” may be associated with a “low risk” of fraud. The fraud model 135 that combines “State A” as a “high risk” attribute and “City A” as a “low risk” attribute may exclude transactions originating from “City A” as potentially fraudulent transactions.

With the fraud models 135 generated, the fraud detection server 120 may be configured to select which fraud model 135 to apply to at least a subset of future retail transactions. The selection may be based, at least in part, on the fraud model 135 predicted to most effectively identify instances of fraud given the smallest subset of retail transactions. The effectiveness of the fraud model 135 may be based, therefore, on a balance between various factors such as the number of instances of fraud the model is able to detect relative to the total number of retail transactions to which the fraud model 135 must be applied. For example, a fraud model 135 that is expected to identify fifty percent (50%) of fraudulent transactions when applied to fifty percent (50%) of retail transactions may be considered to be less effective than a fraud model 135 that is expected to identify ninety percent (90%) of fraudulent transactions when applied to only twenty percent (20%) of retail transactions. The number of fraudulent transactions relative to the number of retail transactions may be predicted based at least in part on previous retail transactions. The fraud detection server 120 may predict the effectiveness of each of the fraud models 135 generated using, e.g., a logistic regression process applying the fraud model 135 to a previous or historical subset of retail transactions. For example, if the fraud model 135 under test would have identified ninety percent (90%) of fraudulent transactions within a subset of previous retail transactions, the fraud detection server 120 may determine the effectiveness of the fraud model 135 under test to be ninety percent (90%). The fraud detection server 120 may further predict that this first fraud model 135 under test will identify approximately ninety percent of the instances of fraud when applied to a future subset of retail transactions.

As described above, the fraud detection server 120 may be configured to select the fraud model 135 predicted to be the most effective at identifying instances of fraud. Effectiveness of a fraud model 135 may be based on the percentage of fraud identified relative to the number of retail transactions considered. Continuing with the example above, the first fraud model 135 may be expected to identify ninety percent (90%) of fraudulent transactions. If, however, a second fraud model 135 is predicted to identify ninety-two percent (92%) of fraudulent transactions within the same subset (e.g., twenty percent) of retail transactions as the first fraud model 135, the fraud detection server 120 may be configured to determine that the second fraud model 135 is more effective than the first fraud model 135. Assuming there are no other fraud models 135 to consider, the fraud detection server 120 may then select the second fraud model 135 as the model to apply to future retail transactions.

The fraud detection server 120 may be configured to select any number of fraud models 135. In one possible implementation, one selected fraud model 135 may be selected for an initial query to identify potentially fraudulent transactions. One or more additional fraud models 135 may be selected to further identify which of the results of the initial query are most likely to be fraudulent or, in the alternative, help prioritize which results to investigate first.

The fraud detection server 120 may be configured to transmit the selected fraud model 135 to the transaction server 105 to apply to incoming retail transactions. The selected fraud model 135 may be used to filter the incoming retail transactions. In other words, the transaction filter may query incoming retail transactions for the attributes identified by the selected fraud model 135. The incoming retail transactions with those attributes may be identified as potentially fraudulent. It may be too cumbersome for the transaction server 105 to apply the selected fraud model 135 to every incoming retail transaction. Therefore, the transaction server 105 may be configured to apply the fraud model 135 to a subset of the incoming retail transactions. Possible subsets may include every tenth or fifth incoming retail transaction, covering ten percent (10%) or twenty percent (20%), respectively, of the incoming retail transactions. When potentially fraudulent transactions are identified, suggesting a possible instance of fraud, the transaction server 105 may transmit an indication of the potentially fraudulent transaction to the fraud instigator computer 125.

The fraud investigator computer 125 may be configured to receive the indication of the potentially fraudulent transaction from the transaction server 105 and, using a processor 140D, present a message to a fraud investigator that indicates that an incoming retail transaction is potentially fraudulent. The fraud investigator may then investigate the incoming retail transaction to verify whether it is indeed fraudulent. The fraud investigator may be an employee of the retailer, an employee of a third party working with the retailer, or a member of law enforcement. Accordingly, the fraud investigator computer 125 may be located at a site owned or operated by the retailer or a third party working with the retailer, or alternatively, the fraud investigator computer 125 may be located at a different site, such as a police station or other law enforcement agency.

In general, computing systems and/or devices, such as the transaction server 105, the user computer, the fraud detection server 120, and the fraud investigator computer 125, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor), such as the processors 140A-140D discussed above, receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor 140 of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

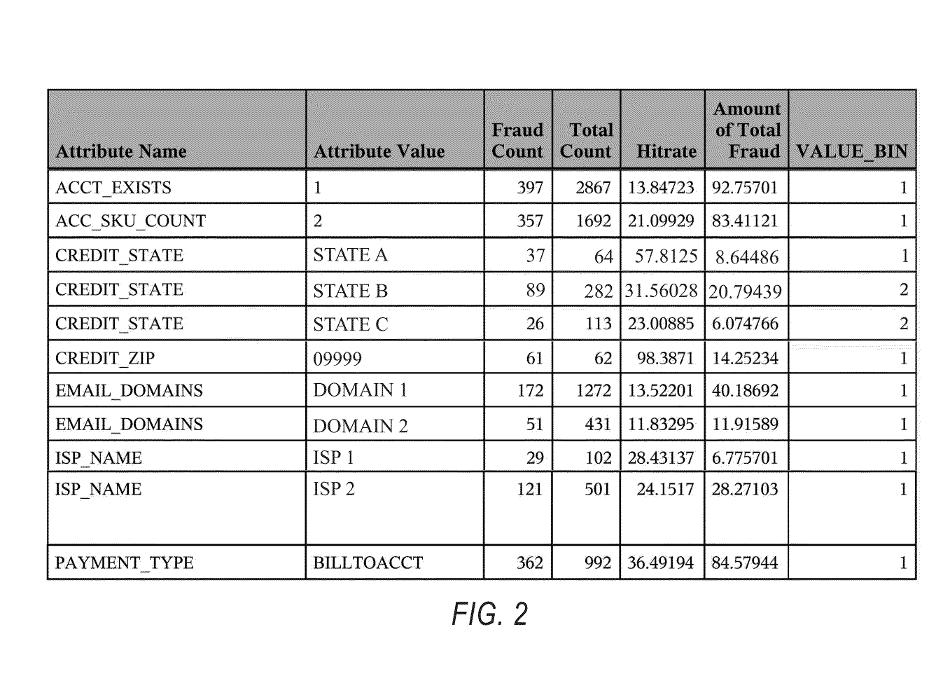

FIG. 2 illustrates an exemplary chart 200 showing attributes and related information that may be used by the fraud detection server 120 to, e.g., determine the fraud risk of each attribute. Any one of these or other attribute may be combined to form any number of fraud models 135. Thus, each fraud model 135 may be a collection of any number of these or other attributes. The example attributes presented in the chart 200 of FIG. 2 include the following: ACCT_EXISTS, SKU_COUNT, CREDIT_STATE, CREDIT_ZIP, EMAIL_DOMAINS, ISP_NAME, PAYMENT_TYPE. The value of the ACCT_EXISTS attribute may represent whether the account associated with the retail transaction is a new account or a previously existing account. The value of the SKU_COUNT attribute may represent the number of a particular item (i.e., two of the same type of mobile device or accessory) included in the same retail transaction. The value of the CREDIT_STATE and CREDIT_ZIP attributes may represent the state and zip code, respectively, of particular transactions. EMAIL_DOMAINS may represent the email address used to place the order and ISP_NAME may represent the Internet service provider (ISP) of the person who placed the order. Finally, PAYMENT_TYPE may represent the method of payment, such as by credit card or “bill to account.” This is just a small sample of the types of attributes that may be associated with retail transactions.

In the example chart 200 of FIG. 2, the values in each of the fields are based on a subset of previous retail transactions. The “Attribute Value” field identifies a datatype, such as a string or integer, which defines the attribute. Generally, an attribute value of “1” could mean “true” or could represent the numeral 1. Other attribute values may include strings such as the name of a state, an email domain, an ISP host name, etc. The “Fraud Count” field indicates the number of times a fraudulent transaction occurred for the identified attribute value. This field may be represented by an integer. The “Total Count” field may represent the total number of previous retail transactions in the subset analyzed where the datatype in the “Attribute Value” field occurred, regardless of whether the transaction was fraudulent. The “Hitrate” field may represent the percentage of fraudulent transactions for the datatype in the “Attribute Value” field relative to all of the transactions analyzed. In one possible implementation, the “Hitrate” may be determined by dividing the “Fraud Count” field by the “Total Count” field and multiplying by 100 to represent percentage. The “Amount of Total Fraud” field may represent the percentage of fraudulent transactions in which the datatype in the “Attribute Value” field occurs. The “VALUE_BIN” field may represent the bin to which the attribute is assigned.

As illustrated, the ACCT_EXISTS attribute has a value of “1” in the “Attribute Value” field. A value of “1” in the “Attribute Value” field indicates that the order was placed under a previously generated customer account. The “Fraud Count” for this datatype indicates that 397 instances of fraud were associated with pre-existing accounts. The “Total Count” value of 2867 indicates that, of the subset of previous retail transactions analyzed, 2867 were orders from pre-existing accounts. The “Hitrate” field is the “Fraud Count” field divided by the “Total Count” field and multiplied by 100 to calculate the percentage of fraudulent transactions in the data set analyzed where the “Attribute Value” was “1.” The “Amount of Total Fraud” field is 92.75701, which means that almost ninety-three percent (93%) of all fraudulent transactions in the subset of retail transactions analyzed were associated with pre-existing accounts (i.e., the “Attribute Value” field is “1”). Because a relatively high number of fraudulent transactions come from pre-existing accounts, the attribute ACCT_EXISTS is added to a bin with a high fraud risk. In the example chart 200 of FIG. 2, the “high fraud risk” is assigned a value of “1” in the VALUE_BIN attribute.

The other attributes presented in the chart 200 of FIG. 2 may be interpreted similarly. Of note, there are multiple values for the attribute “CREDIT_STATE” presented in the chart 200 of FIG. 2. This is because different states have different fraud risks. In the example data presented, thirty-seven (37) fraudulent transactions originated from “State A” while eighty-nine (89) originated from “State B.” “State B,” however, was assigned to “VALUE_BIN” 2 because less than thirty-two percent (32%) of the transactions originating from “State B” were fraudulent while almost fifty-eight percent (58%) of the transactions from “State A” were fraudulent. This example data illustrates how the fraud detection server 120 may weigh the relative likelihood that a transaction is fraudulent based on the value of a particular attribute even though the number of instances of fraud for that attribute may be lower than that of other attributes.

As evidenced by FIG. 2, the fraud detection server 120 may be further configured to combine different attributes of different levels of risk into a single fraud model 135. For instance, if the chart 200 of FIG. 2 represents attributes within a single fraud model 135, “State A” has a high fraud risk (i.e., “VALUE_BIN” is equal to 1) while “State B” has a moderate fraud risk (“VALUE_BIN” is equal to 2). Therefore, the fraud model 135 may include attributes with a high, moderate, or low fraud risk.

The fraud detection server 120 may be configured to define a Boolean relationship between the attributes in the fraud model 135. A retail transaction can only originate from one state, such as “State A” or “State B,” but not both. If the fraud model 135 looked for retail transactions that originate from both “State A” and “State B,” no fraudulent transactions would ever be identified. Therefore, the fraud model 135 may be generated to identify either “State A” or “State B” as potential sources of fraudulent transactions. The fraud model 135 would not require that both be present to identify an instance of fraud. Similarly, the transaction server 105 will likely only accept one email address for the EMAIL_DOMAINS attribute and only one ISP name for the ISP_NAME attribute.

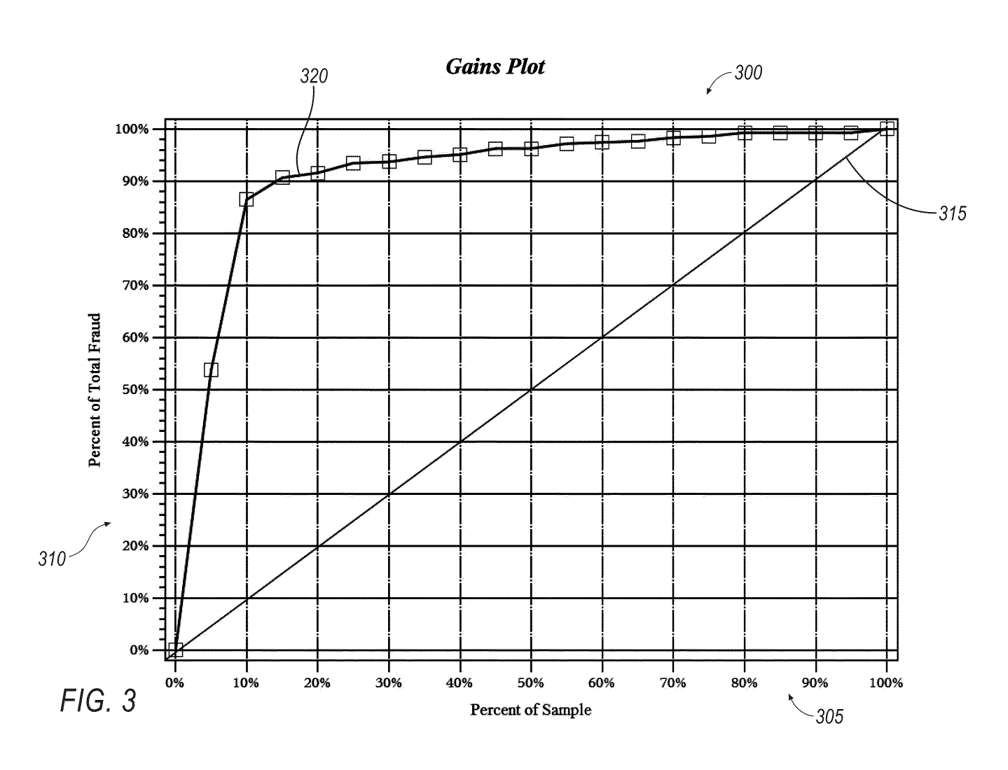

FIG. 3 illustrates an exemplary gains plot 300 representing the effectiveness of a particular fraud model 135 under test relative to a random sampling of the subset of retail transactions. The X axis 305 may represent the percentage of the total number of previous retail transactions included in the sample used to build each of the fraud models 135. The Y axis 310 may represent the percentage of total fraud identified using the fraud model 135 under test. The straight line 315 extending diagonally across the gains plot 300, from the bottom left to the top right, may represent the amount of fraud that would be detected by randomly sampling retail transactions. For instance, if only 10% of retail transactions were randomly sampled, one can expect to detect about 10% of fraudulent transactions. To detect over 80% of fraudulent transactions, over 80% of the retails transactions would need to be sampled. The line represented by numeral 320 represents the percentage of instances of fraud that would have been detected had the fraud model 135 under test been in effect and applied to the subset of retail transactions when those retail transactions were incoming. By considering both the straight line 315 and the line labeled 320, the fraud detection server 120 may be in a better position to determine the effectiveness of the fraud model 135 under test. That is, the fraud detection server 120 may compare the fraud model 135 under test to a control scenario where no fraud model 135 is used.

In the example presented in this gains plot 300, the fraud detection server 120 may predict that almost ninety percent (90%) of fraudulent transactions could have been detected by applying the fraud model 135 under test to only ten percent (10%) of the incoming retail transactions. As shown, the number of instances of fraud detected is above ninety percent (90%) if the fraud model 135 under test is applied to only twenty percent (20%) of the incoming retail transactions. This is a significant improvement compared to the control scenario, which would have only identified twenty percent (20%) of the fraudulent transactions, as shown by line 315. Of course, these numbers are merely exemplary and are dependent upon the particular attributes, and possibly the Boolean relationship between those attributes, associated with the fraud model 135 under test.

The fraud detection server 120 may be configured to generate a gains plot for each fraud model 135 generated. Not only can the fraud detection server 120 automatically (e.g., without human intervention) compare each fraud model 135 to the control scenario, the fraud detection server 120 can also automatically (e.g., without human intervention) compare the effectiveness of each fraud model 135 relative to the other fraud models 135 using the gains plots. Since only one fraud model 135 can be used to filter incoming retail transactions, as discussed above, the fraud detection server 120 may select the fraud model 135 that identifies the most instances of fraud given the fewest number of attributes and by analyzing the smallest percentage of incoming retail transactions. Of course, the fraud detection server 120 may weigh other factors when selecting which fraud model 135 to select and transmit to the transaction server 105.

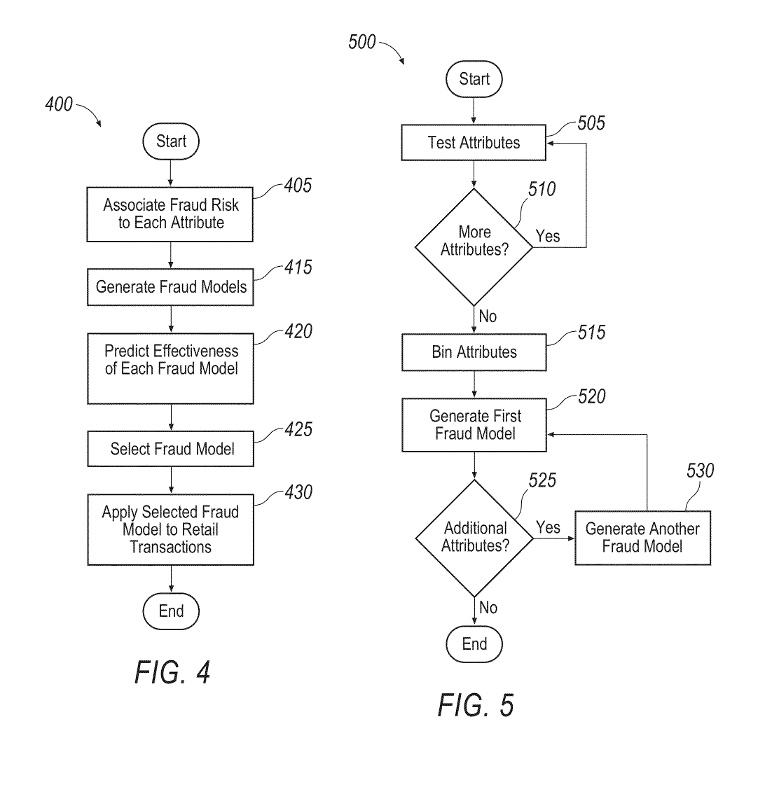

FIG. 4 illustrates an exemplary process 400 that may be implemented by the system 100 to automatically detect fraudulent transactions. The process 400 may be implemented by various system 100 components such as the transaction server 105, the fraud detection server 120, or both.

At block 405, the fraud detection server 120 may associate the fraud risk to each of a plurality of attributes. For instance, the fraud detection server 120 may determine which attributes are commonly associated with fraudulent transactions. This determination may be based on previous retail transactions stored in the retail database 130. The previous retail transactions may indicate whether the transaction was fraudulent. The fraud detection server 120 may consider the fraud risk based on the number of times that attribute has been associated with a fraudulent transaction, as discussed above with respect to FIG. 2.

At block 410, the fraud detection server 120 may generate the plurality of fraud models 135. Each fraud model 135 may represent a potentially fraudulent transaction defined by one or more attributes. An example process for generating the fraud models 135 is described below with respect to FIG. 5 and may include a high level variable reduction technique.

At block 415, the fraud detection server 120 may predict the effectiveness of each of the fraud models 135 generated. Doing so, in one possible approach, may allow the fraud selection model to determine which fraud model 135 generated is most likely to identify the most instances of fraud. The fraud detection server 120 may predict the effectiveness of the fraud model 135 using logistic regression based on, e.g., how the fraud model 135 would have fared if it had been applied to previously received retail transactions. This may be determined using a gains plot, such as the example gains plot 300 presented above with respect to FIG. 3. Using the gains plot or similar metric, the fraud detection server 120 may compare each fraud model 135 to a control scenario where no fraud model 135 is used. Further or in the alternative, the fraud detection server 120 may compare each fraud model 135 to the other fraud models 135 generated.

At block 420, the fraud detection server 120 may select one of the fraud models 135 based on, e.g., whichever fraud model 135 is predicted to most likely to identify the most instances of fraud. As mentioned above, predicting the effectiveness of the fraud models 135 may be based on how well the fraud model 135 would have detected fraud from previous retail transactions, including previous retail transactions that are now known to have been fraudulent. When selecting one of the fraud models 135, the fraud detection server 120 may also consider various factors such as the number of attributes included in the fraud model 135 and the percentage of incoming retail transactions that must be analyzed to identify a minimum percentage of fraud. This way, if two fraud models 135 are predicted to have similar effectiveness, the fraud detection server 120 may be configured to select the one with fewer attributes or the one that can detect a higher percentage of fraud by analyzing a smaller subset of the incoming retail transactions. Once selected, the fraud detection server 120 may transmit the selected fraud model 135 to the transaction server 105 for implementation, as discussed below at block 425.

At block 425, the transaction server 105 may apply the selected fraud model 135 to at least a subset of the incoming retail transactions. The size of the subset of incoming retail transactions to which the selected fraud model 135 is applied may be based on various factors, such as the total number of incoming retail transactions, the predicted effectiveness of the fraud model 135 as represented by, e.g., a gains plot such as the gains plot 300 presented above with respect to FIG. 3, and the computing power of the fraud detection server 120. The particular retail transactions to which the fraud model 135 is applied may be a random selection of retail selections. For instance, if the fraud detection server 120 determines that only ten percent (10%) of the incoming retail transactions should be subject to the fraud model 135, the transaction server 105 may apply the fraud model 135 to every tenth incoming retail transaction. In one exemplary approach, the transaction server 105 may use the fraud model 135 to query at least some of the incoming retail transactions for the attributes included in the fraud model 135. The results of the query may represent instances of fraud identified by the transaction server 105. Identified instances of fraud may be transmitted to the fraud investigator computer 125 for further analysis. In some embodiments, the fraud investigator computer 125 may be associated with a law enforcement agency, such as a police department.

The process 400 may be periodically executed so that current fraud models 135 are selected and applied to incoming retail transactions. In one possible approach, the process 400 may be repeated on the order of every few weeks or longer. In some implementations, however, the process 400 may be repeated at shorter intervals.

FIG. 5 is a flowchart of an exemplary process 500 that may be implemented by the fraud detection server 120 to generate multiple fraud models 135 using different ones or combinations of attributes associated with retail transactions.

At block 505, the fraud detection server 120 may test whether attributes are commonly associated with fraudulent transactions to, e.g., determine the fraud risk of each attribute. The fraud detection server 120 may retrieve attributes from at least a subset of previous retail transactions stored in the retail database 130. The fraud detection server 120 may be configured to consider any number of attributes, including all of the attributes associated with each retail transaction contained in the subset to be analyzed. The fraud risk associated with the attribute may be stored in a database, such as the one discussed above with respect to the “VALUE_BIN” field of FIG. 2. After an attribute has been tested and the fraud risk determined, the process 500 may continue at block 510.

At decision block 510, the fraud detection server 120 may determine whether there are additional attributes that should be tested. If there are, the process 500 may continue with block 505. If there are none, process 500 may continue with block 515. The fraud detection server 120 may conclude that there are no additional attributes to be tested when all of the attributes in the subset of retail transactions have been tested for their fraud risk.

At block 515, the fraud detection server 120 may bin the attributes according to the fraud risk associated with each attribute at block 505. The fraud detection server 120 may read the VALUE_BIN field and bin the attributes accordingly. As discussed above with respect to FIG. 2, a VALUE_BIN field value of “1” may represent a higher risk of fraud than a VALUE_BIN field value of “2” or “3.” After each of the attributes has been binned, the process 500 may continue at block 520.

At block 520, the fraud detection server 120 may generate a first fraud model 135 using, for instance, a high level variable reduction technique to select the attribute or attributes to include in the first fraud model 135. In one possible implementation, the first fraud model 135 may include only one attribute—the one with the highest fraud risk. Of course, the first fraud model 135 may include additional attributes in addition to the one with the highest fraud risk. After the first fraud model 135 has been generated, the process 500 may continue at block 525.

At decision block 525, the fraud detection server 120 may determine whether there are additional attributes that can be used to build additional fraud models 135. For instance, if there is only one attribute associated with fraud, then the fraud detection server 120 may decide to generate only one fraud model 135 having that attribute, in which case the process 500 may end after block 525. If there are multiple attributes, the fraud detection server 120 may decide to generate multiple fraud models 135, each selected to include the attributes associated with the greatest fraud risks. For example, as discussed above, the first fraud model 135 may include the attribute with the greatest fraud risk, the second fraud model 135 may include the two attributes with the greatest fraud risks, the third fraud model 135 may include three attributes with the greatest fraud risks, and so on. The total number of fraud models 135 generated by the fraud detection server 120 may be equal to or greater than the number of attributes available. To continue to generate additional fraud models 135, the process 500 may continue at block 530.

At block 530, the fraud detection server 120 may generate another fraud model 135. This subsequent fraud model 135, relative to the first fraud model 135 generated at block 520, may include the same attribute or attributes included in the first fraud model 135. That is, the fraud detection server 120 may generate the subsequent fraud model 135 to include the attribute with the highest risk as well as at least one other attribute with a relatively lower risk. In other words, subsequent fraud models 135 may include the same attributes as in previously generated fraud models 135 generated as well as an additional attribute that has the high fraud risk among attributes not already included in any of the fraud models 135 (i.e., the previously generated fraud models 135). The fraud detection server 120 may designate a Boolean relationship (AND, OR, AND NOT, etc.) between the two or more attributes included in this subsequent fraud model 135. After the subsequent fraud model 135 has been generated, the process 500 may return to decision block 525 so the fraud detection server 120 can consider whether to generate one or more additional fraud models 135.

The process 500 may be used to generate multiple fraud models 135 having different combinations of attributes based on, e.g., the fraud risk associated with each attribute. The fraud models 135 generated through the process 500 may each include a different number of attributes with varying degrees of associated fraud risk. For instance, the first fraud model generated may have the attribute associated with the highest fraud risk while subsequent fraud models generated may include the same attribute as the first fraud model as well as one or more additional attributes with lower fraud risks. Not all fraud models 135 may be suitable for all situations. Different enterprises may experience fraudulent transactions in different ways so the fraud risk of each attribute may be dependent upon the particular enterprise employing the system 100. Further, applying all fraud models 135, or fraud models 135 with a large number of attributes, to all incoming transactions may be computationally burdensome. Indeed, including additional attributes in a fraud model 135 may not necessarily result in increased fraud detection. Instead, more attributes may result in an unacceptable number of false positives or fraud models 135 that are too stringent to detect clear instances of fraud. Therefore, as discussed above with respect to the process 400, the fraud model 135 selected for implementation by the transaction server 105 may be the fraud model 135 predicted to be most effective at identifying instances of fraud. The effectiveness of each fraud model 135 may be based on a balance between the number of instances of fraud the model is likely to detect relative to the total number of retail transactions to which the fraud model 135 must be applied to detect those instances of fraud. The prediction may be based on empirical data, such as known instances of fraud from previous transactions. The data considered by the fraud detection server 120 may be represented by a gains plot, such as the gains plot 300 presented and discussed above with respect to FIG. 3. By automatically (e.g., without human intervention) comparing the gains plots of multiple fraud models 135, the fraud detection server 120 may predict which is likely to be the most effective.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system comprising:
a transaction server configured to receive and process retail transactions;
a fraud detection server in communication with the transaction server and configured to:
generate a plurality of fraud models from a first subset of the retail transactions, each fraud model identifying at least one potentially fraudulent transaction,
predict an effectiveness of each of the plurality of fraud models to identify potentially fraudulent transactions based at least in part on the first subset of the retail transactions,
select the fraud model based at least in part on the predicted effectiveness, and
transmit the selected fraud model to the transaction server,
wherein the transaction server is configured to apply the selected fraud model to at least a second subset of the retail transactions to identify an instance of fraud.

2. The system of claim 1, wherein the transaction server is configured to apply the selected fraud model by querying at least the second subset of the retail transactions for attributes defined by the selected fraud model, wherein each attribute defines a characteristic of at least one of a consumer, a retailer, and the retail transaction.

3. The system of claim 2, wherein the fraud detection server is configured to generate the plurality of fraud models using attributes commonly associated with fraudulent transactions.

4. The system of claim 3, wherein the fraud detection server is configured to determine which attributes are commonly associated with fraudulent transactions.

5. The system of claim 4, wherein the fraud detection server is configured to bin the attributes commonly associated with fraudulent transactions according to a fraud risk associated with each attribute.

6. The system of claim 5, wherein the fraud detection server is configured to bin attributes with a similar fraud risk together.

7. The system of claim 5, wherein the fraud detection server is configured to generate the plurality of fraud models based at least in part on the fraud risk associated with each attribute.

8. The system of claim 7, wherein the plurality of fraud models includes a first fraud model and a second fraud model, wherein the first fraud model includes a first attribute and wherein the second fraud model includes the first attribute and a second attribute, wherein the first attribute is associated with a higher fraud risk than the second attribute.

9. The system of claim 8, wherein the fraud risks associated with the first attribute and second attribute are determined from the first subset of retail transactions.

10. The system of claim 4, wherein the fraud detection server is configured to determine which attributes are commonly associated with fraudulent transactions based at least in part on previous retail transactions.

11. The system of claim 1, wherein predicting the effectiveness of each fraud model is based at least in part on a logistic regression technique and wherein generating each of the fraud models includes a high level variable reduction technique.

12. A method comprising:
associating a fraud risk to each of a plurality of attributes;
generating, by a computing device, a plurality of fraud models from a first subset of retail transactions, each fraud model identifying at least one potentially fraudulent transaction and including at least one attribute;
predicting an effectiveness of each of the plurality of fraud models to identify potentially fraudulent transactions based on at least in part on the first subset of retail transactions;
selecting, by the computing device, one of the plurality of fraud models based on which fraud model is predicted to identify the most instances of fraud; and
applying the selected fraud model to at least a second subset of retail transactions to identify an instance of fraud.

13. The method of claim 11, wherein applying the selected fraud model includes querying at least the second subset of the retail transactions for the attributes of the selected fraud model, wherein each attribute defines a characteristic of at least one of a consumer, a retailer, and the retail transaction.

14. The method of claim 11, wherein generating the plurality of fraud models includes binning the attributes according to the fraud risk associated with each attribute.

15. The method of claim 11, wherein generating the plurality of fraud models includes generating the plurality of fraud models based at least in part on the fraud risk associated with each attribute.

16. The method of claim 11, wherein generating the plurality of fraud models includes:
generating a first fraud model having a first attribute; and
generating a second fraud model having the first attribute and a second attribute.

17. The method of claim 16, wherein the first attribute is associated with a higher fraud risk than the second attribute.

18. The method of claim 11, wherein associating the fraud risk to the plurality of attributes includes determining which attributes are commonly associated with fraudulent transactions, wherein the determination is based at least in part on previous retail transactions.

19. A non-transitory computer-readable medium tangibly embodying computer-executable instructions comprising:
associating a fraud risk to a plurality of attributes, including a first attribute and a second attribute, wherein the plurality of attributes are associated with a plurality of retail transactions;
generating, by a computing device, a plurality of fraud models from a first subset of the retail transactions, each fraud model identifying at least one potentially fraudulent transaction and including at least one of the first attribute and the second attribute;
predicting an effectiveness of each of the plurality of fraud models to identify potentially fraudulent transactions based at least in part on at least the first subset of the retail transactions;
selecting, by the computing device, one of the plurality of fraud models based on which fraud model is predicted to identify the most potentially fraudulent transactions; and
applying the selected fraud model to at least a second subset of the retail transactions to identify potentially fraudulent transactions.

20. The computer-readable medium of claim 19, wherein generating the plurality of fraud models includes:
binning the plurality of attributes according to the fraud risk associated with each of the plurality of attributes;
generating a first fraud model having the first attribute; and
generating a second fraud model having the first attribute and the second attribute, wherein the fraud risk associated with the first attribute is greater than the fraud risk associated with the second attribute and wherein the fraud risks of the first attribute and the second attribute are determined from the first subset of the retail transactions.
